(19) United States
(12) Patent Application Publication
(10) Pub. No.: US 2009/0238961 A1
(43) Pub. Date: Sep. 24, 2009

(54) Multi-spectral UV identification mark

(76) Inventors: Wayne Worthington, Granbury, TX (US); Mark Siegel, Fort Worth, TX (US); Nancy Bennett, Granbury, TX (US)

Correspondence Address: MARK RODGERS, 1590 SAN ROQUE ROAD, SANTA BARBARA, CA, 93105, US

(21) Appl. No.: 12/079,424

(22) Filed: Mar. 24, 2008

(51) Int. Cl. B05D 7/00

(52) U.S. Cl. 427/157

(57) ABSTRACT

Multi-spectral UV illuminators which can be used in common identification document authentication scenarios have been developed. These illuminators allow the use of multiple UV inks that respond to illumination at differing spectral frequencies to be printed into patterns. Such patterns make possible the production of ID documents which are more secure and harder to counterfeit.

### RELATED APPLICATIONS

Not Applicable

### FEDERALLY SPONSORED RESEARCH

Not Applicable

### SEQUENCE LISTING

Not Applicable

### BACKGROUND OF THE INVENTION

This invention relates to authentication patterns formed by UV inks and in particular patterns produced by using two or more inks which respond to illumination at differing spectral frequencies.

Ultra-Violet marking for identification or authentication has been in use for many years. Examples are UV hand-stamps, patterns formed by UV inks on Identification documents such as drivers licenses and passports, and patterns formed by UV inks on currency or tickets. The technology to view these patterns has, to date, primarily been Fluorescent or Mercury Vapor Backlighting. The manufacturers of UV reactive Inks and Dyes have tailored their products to the frequency of operation of the backlight devices. Many Inks and Dyes are in either the 365 nm, 380 nm or 395 nm optical frequency range. UV light sources are typically very High Q devices, as shown in FIG. 1. So a light source in the 395 nm range will get no reaction from an Ink in the 365 nm or 380 nm range. Marking systems currently select a frequency, and both ink and light source are mated for use.

The inventors have developed a multi-spectral UV illuminator, described in co-pending application Ser. No. 12/011,795, which is incorporated in its entirety by reference. This device is shown in FIG. 2. Illuminator 4 contains three UV LED's 1, 2, and 3, which are chosen to emit at different frequencies. A viewer 5 can observe a marked document 6 illuminated by more than one frequency at a time. Also, as described in the co-pending application, the LED's may be sequenced on and off in patterns. The availability of a practical illuminator of the type shown in FIG. 2 means that more complex UV markings can be used and viewed conveniently in common situations such as checking drivers licenses for age verification in stores or at age-restricted events, or other real-world ID verification scenarios. Thus UV inks may be combined and patterned in ways that greatly enhance security and reduce the possibility of counterfeit documents.

### BRIEF SUMMARY OF THE INVENTION

The invention is a method of marking documents, including printing an authentication pattern on the document using a first UV ink responsive at a first spectral frequency, and printing at least one of a second authentication pattern or an addition to the first pattern in at least one second UV ink responsive at a second spectral frequency. The illumination of the document by a UV source capable of emitting at at least the first and second spectral frequencies is required to authenticate the document.

In one embodiment at least a part of the patterns overlap whereby the first UV ink shows as a first color, the second shows as a second color and overlap area shows as a third color when illuminated by both spectral frequencies

In a preferred embodiment, the patterns are adapted to produce an animation when illuminated by the spectral frequencies sequentially.

### BRIEF DESCRIPTION OF THE DRAWINGS

The invention will be better understood by referring to the following figures.

FIG. 1 shows the spectral response properties of typical UV inks

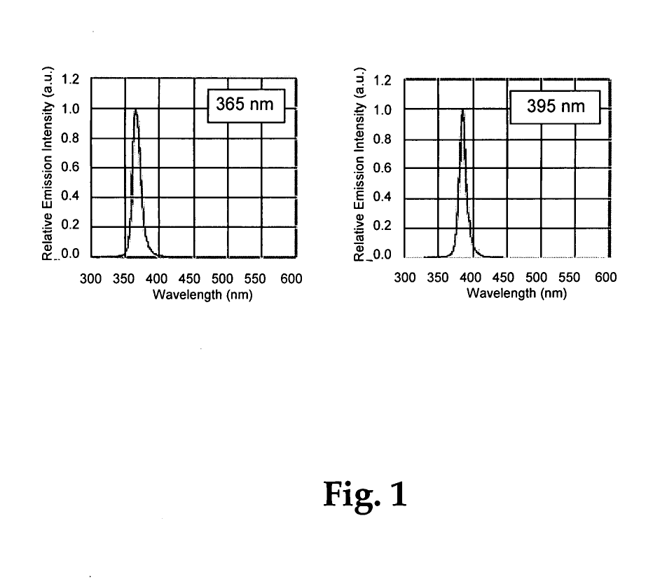

FIG. 2 shows an illuminator of a type used to practice the invention.

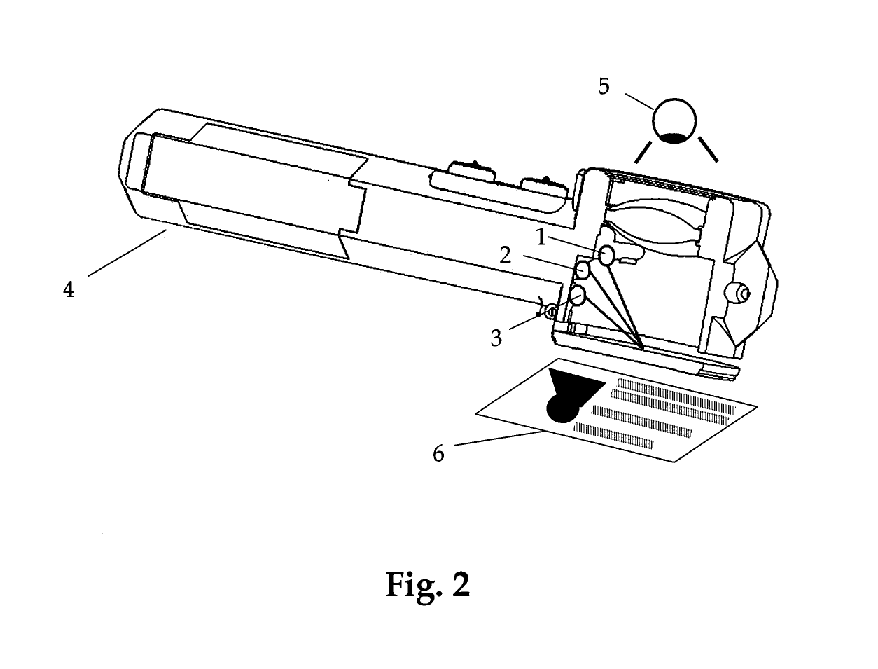

FIG. 3 shows an example of practicing the invention.

FIG. 4 shows a second example of practicing the invention

FIG. 5 shows a third example of practicing the invention

FIG. 6 shows a fourth example of practicing the invention

### DETAILED DESCRIPTION OF THE INVENTION

With a convenient multi-spectral source, multiple ink types with different spectral response can be printed on single documents. This enables an array of options. In the general case, a pattern of some sort is printed with one ink with its spectral response, and either a second pattern or an overlapping pattern is printed with another ink with a different spectral response. Depending on the type of illuminator available, more than two inks may be used as well. The patterns are so configured that without illuminating at more than one UV frequency, the expected results will not show, thereby requiring the multi-spectral illumination to authenticate the document. Thus a document becomes much harder to counterfeit, requiring both knowledge of and availability of the differing inks. Because it takes multiple UV frequencies to detect the full image of the pattern, unless the counterfeiter has the specialized illuminator they may never even know of all the elements of the security markings.

Several specific examples of the invention are shown, with the understanding that other approaches within the scope of the broad invention will occur to one skilled in the art.

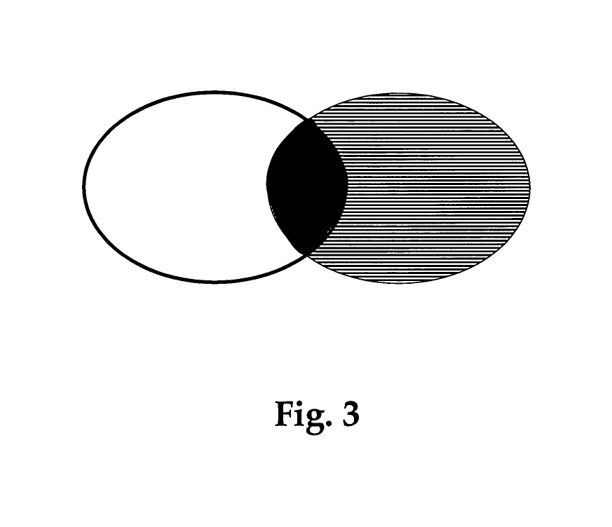

As shown in FIG. 3, one frequency dye of one color and the other frequency dye of a second color may be printed such that they at least partially overlap. When both are lighted they produce a third color, one frequency for a background image and the other frequency of a foreground image, only both frequencies show the entire image.

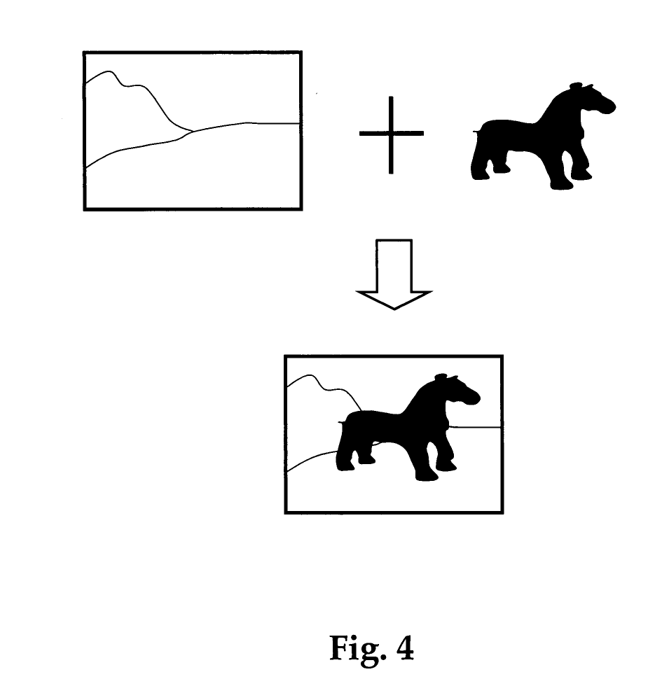

FIG. 4 shows a case where two different frequencies are used to show a full image. The background image would be printed with ink of one frequency, the horse image would be printed with ink of a different frequency. Only when viewed through a device that illuminates both frequencies simultaneously does the image appear as one full image. A device that illuminates only one frequency would not have both images appear together.

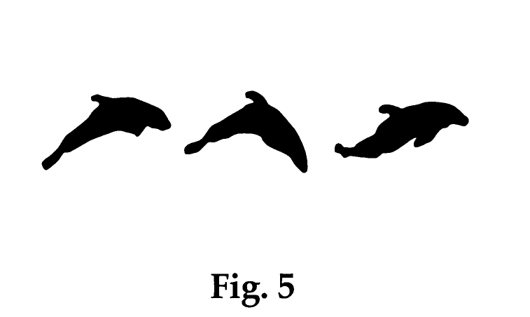

FIG. 5 shows a case where inks of different spectral response are used for an animation, exemplified by three frames of a dolphin moving. The illuminator might be programmed to follow a pattern such as,
Freq 1 on/Freq 2 off/Freq 3 off
Freq 1 off/Freq 2 on/Freq 3 off
Freq 1 off/Freq 2 off/Freq 3 on—and repeat.
   If the cycle happened at a relatively short interval, say some fraction of a second, a smooth animation would result.

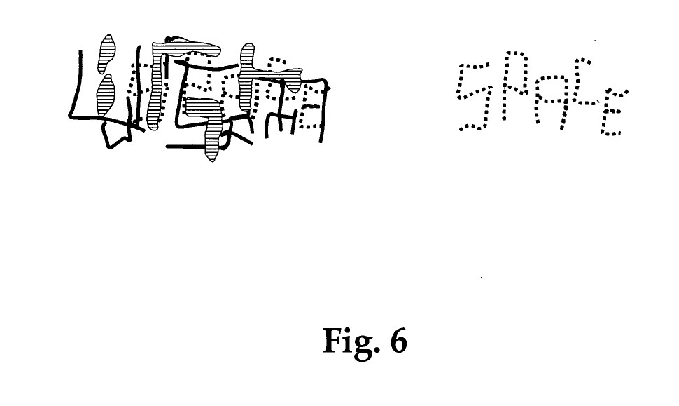

FIG. 6 shows another example where regular color ink is combined with UV ink to create a garbled message. When the correct UV frequency is applied the message is decoded. By placing various colored UV Dyes over to top of the colored image, when the UV dye is activated by the UV light the Dye becomes a filter to expose only one of the images underneath. The mix of all the different images the multiple frequencies will allow a single coherent image to be displayed. So looking at the image normally its just a jumble of color, when the UV acts as a filter the information is displayed.

We claim:

1. A method of marking documents, comprising;
printing an authentication pattern on the document using a first UV ink responsive at a first spectral frequency; and,
printing at least one of a second authentication pattern or an addition to the first pattern in at least one second UV ink responsive at a second spectral frequency; whereby, illumination of the document by a UV source capable of emitting at at least the first and second spectral frequencies is required to authenticate the document.

2. The method of claim 1 wherein at least a part of the patterns overlap whereby the first UV ink shows as a first color, the second shows as a second color and overlap area shows as a third color when illuminated by both spectral frequencies.

3. The method of claim 1 wherein the patterns are adapted to produce an animation when illuminated by the spectral frequencies sequentially.
